(19) United States
(12) Patent Application Publication
(10) Pub. No.: US 2009/0312674 A1
(43) Pub. Date: Dec. 17, 2009

(54) ELECTROMAGNETIC VALVE AND PNEUMATIC MASSAGE APPARATUS

(76) Inventors: Haruki Nakao, Tokyo (JP); Hiroki Kawashima, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/308,698

(22) PCT Filed: Jun. 28, 2007
(86) PCT No.: PCT/JP2007/062964

§ 371 Date: Mar. 17, 2009

(30) Foreign Application Priority Data
Jun. 29, 2006 (JP) 2006-180117
Oct. 31, 2006 (JP) 2006-295757

(51) Int. Cl. F16K 31/06; F16K 15/18; A61H 7/00

(52) U.S. Cl. 601/9; 137/599.18; 251/129.2; 601/11

(57) ABSTRACT

A compact and lightweight electromagnetic valve with a check valve is provided. In the electromagnetic valve, a plunger 16 is moved toward an end wall 22 of a housing of the electromagnetic valve by applying a voltage to a solenoid 14. Then, an annular valve seat engaging portion 64 of a valve member 48 attached to the plunger is urged against a valve seat around a fluid outlet 26 formed in the end wall 22 while being elastically deformed, thereby closing the fluid outlet 26. At the same time, a valve pressing member 46 attached to the plunger is separated from a valve member 52 disposed at a fluid opening 24 of an end wall 20 of the housing. Thus, the valve member 52 disposed at the fluid inlet 24 of the housing functions as a check valve to allow pressurized air to flow in from a pump. In a case where a voltage is not applied to the solenoid 14, the plunger 16 is biased toward the fluid inlet by means of a compression spring 60. Therefore, the valve pressing member 46 urges the first valve member 52 against a valve seat around the fluid inlet 24 to close the fluid inlet 24. The second valve member 48 is separated from the fluid outlet 26, whereby the fluid outlet 26 is opened and pressurized air is discharged to the atmosphere.

### TECHNICAL FIELD

The present invention relates to an electromagnetic valve actuated by a solenoid, and a pneumatic massage apparatus using the electromagnetic valve.

### BACKGROUND ART

In a pneumatic massage apparatus having a plurality of air chambers and making an effect on a human body by successively expanding and contracting the air chambers, in general, electromagnetic valves in the same number as that of the air chambers are used to control supply and exhaust of air thereto and therefrom the air chambers (see Japanese Unexamined Patent Application Publication No. 2000-189477).

FIG. 1 shows an example of such an electromagnetic valve.

This electromagnetic valve 100 includes a tubular housing 112, a solenoid coil 114 disposed in the housing, and a displaceable valve 116 displaceable in an axial direction of the housing by the action of the solenoid. By alternately applying a voltage to the solenoid and stopping the application, the displaceable valve 116 reciprocates, thereby acting so as to alternately close a fluid inlet 124 and a fluid outlet 126 of the housing 112. The housing 112 is provided, on the side of the fluid inlet 124 thereof, with a check valve 102. The check valve 102 has a duckbill-type check valve 118, and acts so as to allow a fluid to flow in from a fluid source connecting port 130 and to prevent the fluid from flowing out.

When used in a pneumatic massage apparatus, the electromagnetic valve is provided for each of a plurality of air chambers of the massage apparatus, the fluid source connecting port 130 is connected to a hose extending from a pump, a fluid port 128 is connected to the air chamber of the pneumatic massage apparatus, and the fluid outlet 126 is opened to the atmosphere. When the massage apparatus is actuated, a voltage is first applied to a solenoid of an electromagnetic valve corresponding to a first air chamber of the massage apparatus, whereby the fluid inlet 124 is opened and the fluid outlet 126 is closed. Thus, pressurized air is supplied from the pump through the electromagnetic valve to the first air chamber, whereby the first air chamber is expanded. When the pressure inside the first air chamber reaches a predetermined value, an electromagnetic valve corresponding to a second air chamber is actuated to start air supply to the second air chamber, whereby the pressure inside the hose extending from the pump is reduced. Therefore, the check valve 118 of the electromagnetic valve corresponding to the first air chamber closes the fluid source connecting port 130, thereby preventing pressurized air from flowing from the first air chamber back to the hose. If the application of the voltage to the solenoid 114 of the electromagnetic valve corresponding to the first air chamber is stopped at a predetermined timing, the fluid outlet 126 is opened and the fluid inlet 124 is closed, whereby pressurized air in the first air chamber is released through the fluid outlet 126 to the atmosphere. By successively actuating second, third, and following electromagnetic valves in the same manner, the air chambers successively and alternately expand and contract, thereby providing a massaging effect.

FIG. 2 shows an electromagnetic valve 200 provided with a check valve 202 having an umbrella-type valve 218 instead of the check valve 102 having the duckbill-type valve 118 in FIG. 1. This umbrella-type valve may cause resonance noise when a fluid flows in.

### DISCLOSURE OF THE INVENTION

### Problems to Be Solved by the Invention

As described above, pneumatic massage apparatuses worn on a human body tend to have more air chambers in order to provide a better massaging effect. Therefore, especially in electromagnetic valves used in such apparatuses, reduction in size and weight is required.

### Means for Solving the Problems

In view of the forgoing, the present invention provides an electromagnetic valve including:

a housing (12) having a fluid inlet (designated as reference numeral 24 in the embodiment described below), a fluid outlet (26), and a fluid port (28);

a solenoid (14) disposed in the housing;

a plunger (16) displaceable between a first position and a second position in the housing by an action of the solenoid;

a first valve member (52) disposed in the housing and acting as a check valve for allowing a fluid to flow through the fluid inlet (24) into the housing (12) and preventing the fluid from flowing out; and,

a valve pressing member (46) which is connected to the plunger (16), and which urges the first valve member (52) against a valve seat around the fluid inlet (24) to close the fluid inlet when the plunger is at the second position and is separated from the first valve member when the plunger is at the first position (FIG. 3).

In this electromagnetic valve, in a case where the pressure outside the fluid inlet (24) (i.e., the pressure on the side of a fluid source to which the fluid inlet is connected) is higher than that inside the fluid inlet (i.e., the pressure inside the housing) when the plunger is at the first position, the valve member (52) is opened to allow a fluid to flow in through the fluid inlet (24). In the reverse case, the valve member acts so as to prevent a fluid from flowing in and out. When the plunger is at the second position, the valve member (52) is urged by the valve pressing member (46) against the valve seat around the fluid inlet (24), thereby preventing a fluid from flowing in and out through the fluid inlet (24) regardless of the relationship between the pressure inside the fluid inlet (24) and that outside the fluid inlet. Thus, in this electromagnetic valve, one valve member (52) serves as both the check valve 102 and the displaceable valve (116) for opening and closing the fluid inlet in this type of conventional electromagnetic valve described above, whereby it is possible to reduce the size and weight of the electromagnetic valve.

Specifically, the first valve member (52) is formed of a flexible plate-shaped member and disposed so as to contact with the valve seat, and the valve pressing member (46) engages with a radially inside portion of to the first valve member relative to the valve seat and urge the radially inside portion toward the fluid inlet (24) when the plunger is at the second position, thereby pressing the first valve member against the valve seat.

Further, the valve seat is circular in shape, the plunger (16) is displaceable along an extended line of an axis line of the fluid inlet (24), and the valve pressing member (46) has a valve pressing surface (46-2) convex toward the first valve member (52) about the axis line and can urge the first valve member by means of the valve pressing surface.

More specifically, the valve pressing surface may be spherical in shape.

In this way, when the valve pressing member (46) urges the first valve member (52), the first valve member is curved convexly toward the fluid inlet (24) and then surely engaged with the valve seat around the fluid inlet over the entire circumferential direction of the valve seat, whereby sealing is provided. In a case where the valve pressing member has an annular pressing portion corresponding to the valve seat and urges the first valve member against the valve seat by means of the annular pressing portion, if the valve pressing member is inclined, it is difficult to surely urge the first valve member against the valve seat over the entire circumferential direction of the valve seat by means of the pressing portion. In contrast to this, with the above-described valve pressing member, it is possible to solve such a problem.

Further, the first valve member (52) may have a check valve portion mounted at one end portion thereof to the inner wall surface of the housing so that the check valve portion is pivotable about the one end portion to engage with and disengaged from the valve seat thereby closing and opening the fluid inlet.

Specifically, the housing has a tubular wall (18), a first end wall (20) closing one end of the tubular wall, and a second end wall (22) closing the other end. The fluid inlet (24) is formed so as to extend through the first end wall. The first valve member (52) is formed of a flexible plate-shaped member, and has a peripheral portion (52-2) sealingly engaged and secured between the first end wall (20) and the tubular wall (18), a central portion (52-1) engageable with the valve seat, and a connecting portion (52-3) connecting the central portion and the peripheral portion. The central portion (52-1) can act as the check valve portion by pivoting about the connecting portion.

The electromagnetic valve further has a spring member (60) for biasing the plunger (16) in a direction in which the plunger (16) is displaced from the first position to the second position. The fluid outlet (26) is formed so as to extend through the second end wall (22). The fluid port (28) is formed so as to extend through the tubular wall (18). The plunger (16) is configured to be displaced from the second position to the first position by being attracted by the solenoid (14). The plunger (16) may have a second valve member (48) engageable with a valve seat around the fluid outlet to close the fluid outlet when the plunger is at the first position.

Specifically, the second valve member (48) has a flexible conical-shaped valve seat engaging portion (64) radially outwardly extending toward the fluid outlet (26). When the plunger moves to the first position, the flexible valve seat engaging portion can move close to a given position close to the valve seat while being elastically deformed so as to radially extend by engaging with the valve seat around the fluid outlet to radially expand.

In this case, when closing the fluid outlet, the valve seat engaging portion of the second valve member can surely close the fluid outlet with a small pressing force by engaging with the valve seat around the fluid outlet while being elastically deformed, whereby it is possible to reduce the size and weight of the solenoid. In addition, the amount of compression of the valve seat engaging portion against the valve seat can be large, whereby it is possible to accommodate the accumulation of manufacturing tolerances and to surely open and close the fluid outlet.

The present invention also provides a pneumatic massage apparatus including a massage device (312) which is configured to be worn on a human body and which has a plurality of air chambers (340) that are expanded and contracted by supplying and discharging pressurized air thereto and therefrom to thereby making an effect on a human body, and a pump (342) separated from the massage device (312) and supplying pressurized air to the air chambers. The pneumatic massage apparatus further includes the above-described electromagnetic valves (10) provided for respective the air chambers (340) and configured to control supply and discharge of the pressurized air thereto and therefrom respective the air chambers. The fluid inlet (24), the fluid outlet (26), and the fluid port (28) of each of the electromagnetic valves are communicated with an air supply hose (325) extending from the pump, the atmosphere, and the corresponding air chamber, respectively. Specifically, the electromagnetic valves are attached to the massage device.

As described above, the electromagnetic valves used in this pneumatic massage apparatus are more compact and lightweight than conventional electromagnetic valves. Therefore, even if the pneumatic massage apparatus is provided with a plurality of electromagnetic valves according to the number of air chambers, the total weight of the apparatus can be reduced and thus the apparatus can be user-friendly.

### ADVANTAGEOUS EFFECTS OF THE INVENTION

In the electromagnetic valve according to the present invention, one valve member serves as both the check valve and the valve member for opening and closing the fluid inlet in this type of conventional electromagnetic valve described above, whereby it is possible to reduce the size and weight of the electromagnetic valve. Further, in the recent trend in which more air chambers are used, the pneumatic massage apparatus using such electromagnetic valves according to the present invention can be lightweight and convenient to use.

### BRIEF DESCRIPTION OF THE DRAWINGS

FIG. 1 is a sectional view showing a first conventional example of an electromagnetic valve equipped with a check valve.

FIG. 2 is a sectional view showing a second conventional example of an electromagnetic valve equipped with a check valve.

FIG. 3 is a sectional view of an electromagnetic valve according to an embodiment of the present invention.

FIG. 4 is a cross-sectional view taken along line A-A in FIG. 3.

FIG. 5 is a sectional view of a principal part of an electromagnetic valve having a valve pressing member according to another embodiment, showing a state in which the valve pressing member is apart from a first valve member.

FIG. 6 is a sectional view same as FIG. 5, but showing a state in which the valve pressing member is pressing the first valve member.

FIG. 7 is a schematic diagram of a pneumatic massage apparatus according to an embodiment of the present invention.

FIG. 8 is a cross-sectional view taken along line B-B in FIG. 3.

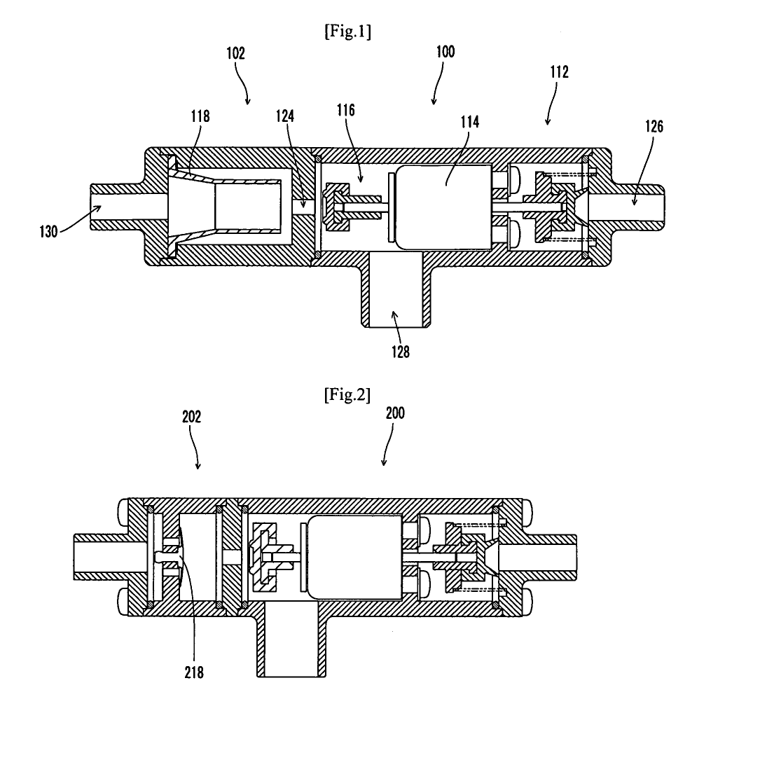

### BEST MODE FOR CARRYING OUT THE INVENTION

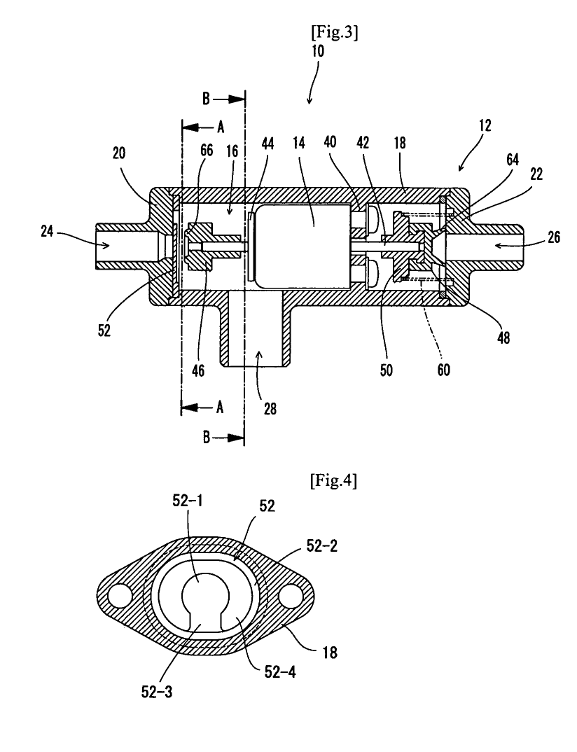

An embodiment of an electromagnetic valve according to the present invention will now be described with reference to FIGS. 3 and 4.

FIG. 3 is a sectional view of the electromagnetic valve according to the embodiment of the present invention. As shown in FIG. 3, the electromagnetic valve 10 has a tubular housing 12, a solenoid 14 disposed in the housing, and a plunger 16 which is displaced in an axial direction of the housing when a voltage is applied to the solenoid 14.

The housing 12 has a tubular wall 18, a first end wall 20, and a second end wall 22. The first end wall 20, the second end wall 22, and the tubular wall 18 are provided with a fluid inlet 24, a fluid outlet 26, and a fluid port 28, respectively, extending therethrough.

The plunger 16 has a rod 42 extending through a through hole of the solenoid, and a disc-shaped armature 44 secured to the rod 42 on the side of the fluid inlet 24 with respect to the solenoid 14 and made of magnetic material such as steel. The rod 42 is provided at the left end thereof with a valve pressing member 46, and at the right end thereof with a second valve member 48. A spring retaining portion 50 is attached to the rod 42 so as to be adjacent to the second valve member 48. A compression spring 60 is disposed between the spring retaining portion 50 and the second end wall and biases the plunger 16 toward the fluid inlet.

The first valve member 52 is formed of a flexible plate-shaped member made of elastomeric material such as rubber, and is sandwiched between the tubular wall 18 and the first end wall 20 so as to contact with the inner wall surface of the tubular wall 18. As shown in FIG. 4, the first valve member is provided with a C-shaped hole 52-4 and composed of a central portion 52-1, a peripheral portion 52-2, and a connecting portion 52-3. The central portion 52-1 is generally circular in shape and has a size enough to cover the fluid inlet 24 from the inside. When engaging with a valve seat portion around the inner side of the fluid inlet, the central portion 52-1 acts so as to close the fluid inlet. The peripheral portion 52-2 is sealingly engaged with a groove formed at a connecting portion between the first end wall 20 and the tubular wall 18, thereby securing the whole of the first valve member 52 with respect to the housing and also acting as a sealing component for preventing leakage of a fluid from a gap between the first end wall 20 and the tubular wall 18.

The valve pressing member 46 is made of resin, metal, or the like, and has an annular protrusion 66 for pressing the first valve member 52 against the valve seat around the fluid inlet. The second valve member 48 has a valve seat engaging portion 64 provided on a surface facing the second end wall 22. The valve seat engaging portion 64 is conical in shape so as to radially outwardly extend toward the second end wall 22.

The housing 12 has an annular solenoid retaining wall 40 formed on the inner surface of the tubular wall 18, and the solenoid 14 is secured to the solenoid retaining wall so as to be coaxial with the housing 12. The solenoid retaining wall 40 is provided with air passages 41 (see FIG. 8).

The operation of the above-described electromagnetic valve 10 will now be described.

When a voltage is applied to the solenoid 14, the armature 44 is attracted to the end surface of the solenoid 14 by an electromagnetic force generated by the solenoid 14, and the plunger 16 is moved toward the second end wall 22 as shown in FIG. 3. In this state, the annular valve seat engaging portion 64 of the second valve member 48 is urged against a valve seat around the fluid outlet 26 while being elastically deformed to close the fluid outlet 26, and the valve pressing member 46 is apart from the first valve member 52.

In this case, the opening and closing operation of the fluid inlet 24 depends on the check valve operation of the first valve member 52. In other words, if the pressure outside the fluid inlet is higher than that inside the fluid inlet, the differential pressure causes the central portion 52-1 of the first valve member 52 to be pushed from the outside of the fluid inlet to open the fluid inlet, and the connecting portion 52-3 is elastically curved. If the pressure outside the fluid inlet is lower than that inside the fluid inlet, the central portion 52-1 is urged against the valve seat around the fluid inlet 24, and thus the fluid inlet 24 is closed. Thus, the central portion 52-1 of the first valve member 52 acts as a check valve for the fluid inlet.

In a case where a voltage is not applied to the solenoid 14, the plunder 16 is displaced toward the fluid inlet by means of the compression spring 60, and the valve pressing member 46 urges the first valve member 52 against the valve seat of the fluid inlet 24 to close the fluid inlet 24. The second valve member 48 is separated from the valve seat of the fluid outlet 26 to open the fluid outlet 26.

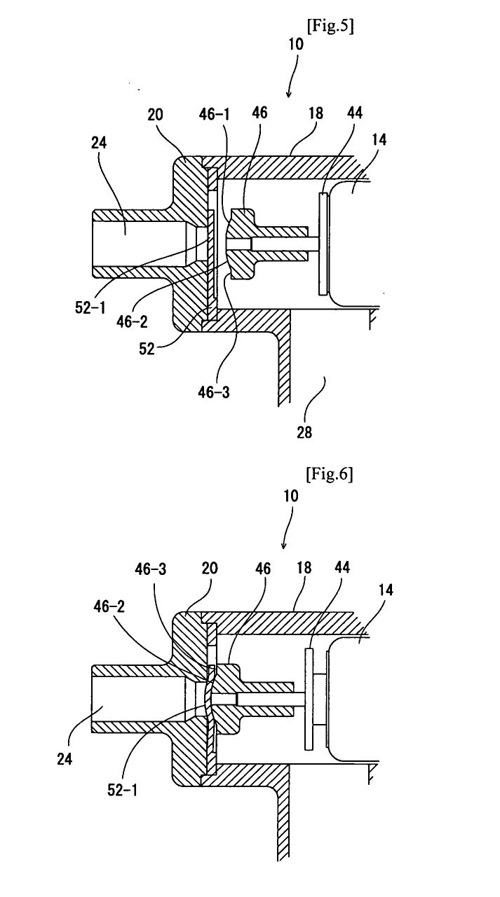

FIGS. 5 and 6 show another embodiment of the valve pressing member 46 of the above-described electromagnetic valve.

In this valve pressing member 46, a front surface 46-1 facing the first valve member 52 has a curved surface convex toward the first valve member. Specifically, an end opening of the fluid inlet 24 extending through the first end wall 20 to the inner surface of the first end wall 20 is circular in shape, the valve seat around the end opening on the inner surface of the first end wall 20 is circular in shape, the valve pressing member 46 is configured to move leftward and rightward (as viewed in the figure) along an axis line of the fluid inlet 24, and the front surface of the valve pressing member 46 has a spherical-shaped valve pressing portion 46-2 convex toward the first valve member about the axis line and an annular portion 46-3 around the valve pressing portion. With this arrangement, when the plunger is moved toward the first end wall 20 and then the valve pressing member 46 urges the first valve member 52 as shown in FIG. 6, the spherical-shaped valve pressing portion 46-2 first contacts, at the central tip portion thereof, with the center of the central portion 52-1 of the plate-shaped first valve member 52, and then gradually urges the central portion 52-1 against the valve seat (especially, a circular periphery of the end opening of the fluid inlet 24, which forms the inner edge of the valve seat) while curving the central portion convexly toward the outside of the fluid inlet 24 such that the central portion follows the valve pressing portion 46-2. The spherical-shaped valve pressing portion 46-2 is configured to extend to the outside of a diameter of the end opening of the fluid inlet 24. Therefore, the central portion 52-1 of the first valve member is not curved by more than the curvature of the spherical surface of the valve pressing portion.

The valve pressing member 46 according to this embodiment is configured to urge the central portion 52-1 of the first valve member, on the inner side thereof with respect to the periphery of the end opening of the fluid inlet 24, toward the outside of the fluid inlet 24, thereby pressing the peripheral portion of the central portion against the valve seat. Therefore, even if the valve pressing member is slightly inclined, it is possible to urge the central portion against the valve seat over the entire circumferential direction, whereby sure sealing can be provided.

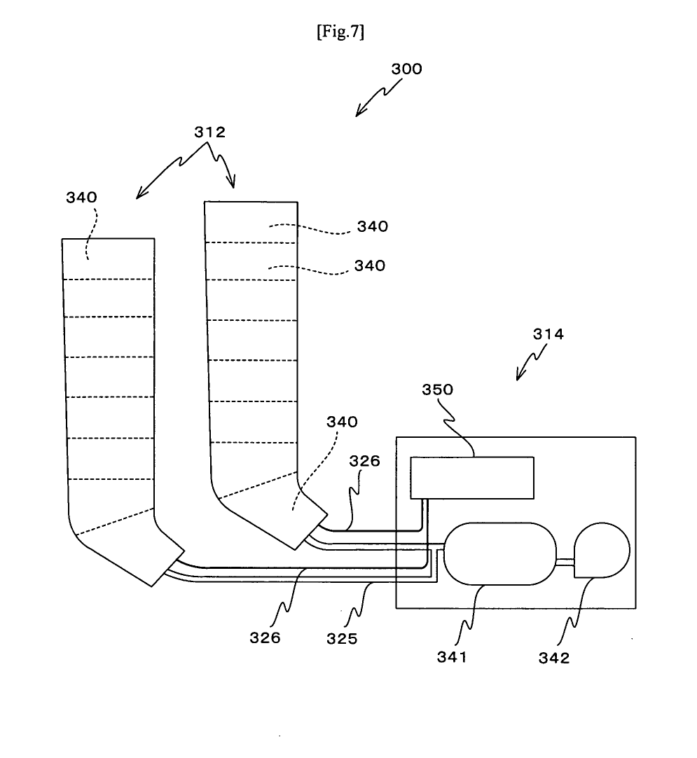

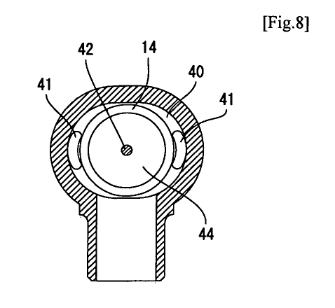

FIG. 7 shows a pneumatic massage apparatus 300 using the above-described electromagnetic valve.

The pneumatic massage apparatus 300 includes a pair of tubular massage devices 312 which are worn around the left and right lower limbs of a user, and a pneumatic massage apparatus main unit 314 having a pump 342 placed on a floor or the like adjacent to the user wearing the massage devices. A hose 325 for supplying pressurized air from the pump 342 extends via a tank 341 in the longitudinal direction of the massage device 312, and connected to electromagnetic valves 10 provided for respective air chambers 340 arranged successively along the longitudinal direction of the massage device 312. The massage apparatus main unit has a control unit 350 which controls the electromagnetic valves through control signal lines 326.

In this case, the fluid inlet 24, the fluid port 28, and the fluid outlet 26 of the electromagnetic valve 10 are configured to be communicated with the hose 325, the air chamber 340 of the massage apparatus, and the atmosphere, respectively.

In operation of the massage apparatus 300, the air chambers arranged successively along the longitudinal direction of the massage device 312 are expanded and contracted successively in a predetermined order. Expansion and contraction of each of the air chambers is performed as follows. A voltage is first applied to the solenoid 14, and then the plunger 16 is moved toward the second end wall, whereby the fluid outlet 26 is closed and the valve pressing member 46 is separated from the first valve member. Thus, the first valve member 52 is opened by pressurized air supplied from the pump, and then the pressurized air flows into the air chamber to expand the air chamber. When the pressure inside the air chamber reaches a predetermined value, the first valve member 52 acts as a check valve to prevent pressurized air from flowing from the electromagnetic valve to the hose. In this state, the plunger is still maintained at the same position. Then, when the application of a voltage to the solenoid 14 is stopped at a predetermined point of time, the spring member 60 moves the plunger 16 toward the fluid inlet, and then the valve pressing member 46 urges the first valve member 52 against the valve seat around the fluid inlet 24 to close the fluid inlet and the fluid outlet 26 is opened. Thus, pressurized air in the air chamber is fed through the housing 12 and discharged from the fluid outlet 26 to the atmosphere, whereby the air chamber is contracted. At this time, the solenoid 14 is compulsory cooled due to pressurized air flowing in the housing. By alternately applying a voltage to the solenoid 14 and stopping the application as described above, it is possible to alternately expand and contract the air chambers to make an effect on a human body as a massage apparatus.

As can be seen from the above description, the present invention can provide a compact and lightweight electromagnetic valve having a check valve function. Therefore, by using this electromagnetic valve to control supply and exhaust of air thereto and therefrom a pneumatic massage apparatus which in use is worn on a human body, it is possible to reduce the weight and to enhance usability of the massage apparatus.

Further, the valve seat engaging portion 64 of the second valve member is conical in shape so as to radially extend toward the second end wall. Therefore, the amount of compression of the valve seat engaging portion 64 is large, and a change in a reaction force with respect to the amount of compression is small, whereby it is possible to properly close the fluid outlet 26 regardless of accumulation of manufacturing tolerances of the electromagnetic valve.

The electromagnetic valve according to the present invention may be applied not only to pneumatic massage apparatuses but also to apparatuses in which a check valve and an electromagnetic valve need to be used in combination.

1-10. (canceled)

11. An electromagnetic valve comprising:
a housing having a tubular wall, a first end wall having an interior surface and an exterior surface and closing one end of the tubular wall, a second end wall having an interior surface and an exterior surface and closing an other end of the tubular wall, a fluid inlet extending through the first end wall from the exterior surface to the interior surface of the first end wall to form a circular opening in an interior surface of the first end wall that has an axis extending in an axial direction of the tubular wall, a fluid outlet extending through the second end wall from the exterior surface to the interior surface of the second end wall to form an opening in the interior surface of the second end wall coaxially with the opening of the fluid inlet, and a fluid port radially extending through the tubular wall;
a solenoid disposed in the housing;
a plunger disposed in the housing extending in the axial direction of the tubular wall and displaceable between a first position and a second position in the housing by an action of the solenoid;
a first valve member made of a flexible plate-shaped member and disposed on the interior surface of the first end wall of the housing and configured to prevent a fluid from flowing out of the housing through the fluid inlet by engaging with the interior surface of the first end wall around the opening of the fluid inlet and to allow a fluid to flow into the housing through the fluid inlet by at least partially disengaging from the interior surface;
a valve pressing member provided at one end of the plunger, the valve pressing member being configured to press the first valve member against the interior surface of the first end wall to prevent the first valve member from disengaging from the interior surface of the first end wall when the plunger is at the second position, and to be separated from the first valve member to enable the first valve member to disengage from the interior surface when the plunger is at the first position, the valve pressing member having a spherical surface convex toward the first valve member having a center of curvature through which the axis of the opening of the fluid inlet passes, the spherical surface being advanced into the opening of the fluid inlet and urgingly engaging with the first valve member when the plunger is at the second position so that the first valve member is sealingly engaged with the interior surface of the first end wall around the circular opening of the first end wall; and
a second valve member disposed on an other end of the plunger and configured to close the fluid outlet by elastically engaging with an interior surface of the second end wall around the opening of the fluid outlet when the plunger is at the first position and to open the fluid outlet by being apart from the interior surface of the second end wall when the plunger is at the second position;
the fluid port being selectively communicated with the fluid inlet and the fluid outlet by selectively moving the plunger to the first position and the second position, respectively.

12. An electromagnetic valve according to claim 11,
the first valve member is formed of a flexible plate-shaped member, and comprises a peripheral portion sealingly engaged and secured between the first end wall and the tubular wall, a central portion engageable with the interior surface of the first end wall around the opening of the fluid inlet, and a connecting portion connecting the central portion and the peripheral portion; and the central portion is configured to disengage from the interior surface of the first end wall by pivoting about the connecting portion.

13. An electromagnetic valve according to claim 11, wherein:
the second valve member has a flexible conical-shaped engaging portion radially outwardly extending toward the fluid outlet; and when the plunger is moved to the first position, the flexible conical-shaped engaging portion engages the interior surface of the second end wall around the opening of the fluid outlet while being elastically radially outwardly expanded to sealingly close the fluid outlet.

14. An electromagnetic valve according to claim 13, wherein:
the second valve member has a flexible conical-shaped engaging portion radially outwardly extending toward the fluid outlet; and when the plunger is moved to the first position, the flexible conical-shaped engaging portion engages the interior surface of the second end wall around the opening of the fluid outlet while being elastically radially outwardly expanded to sealingly close the fluid outlet.

15. A pneumatic massage apparatus comprising:
a massage device configured to be worn on a human body, the massage device comprising a plurality of air chambers that are expanded and contracted by supplying and discharging pressurized air thereto and therefrom to thereby making an effect on a human body; and,
a pump for supplying pressurized air to the air chambers, the pump being separated from the massage device, wherein:
the pneumatic massage apparatus further comprises electromagnetic valves according to claim 11 provided for the respective air chambers and configured to control supply and discharge of the pressurized air thereto and therefrom respective the air chambers; and,
the fluid inlet, the fluid outlet, and the fluid port of each of the electromagnetic valves are communicated with an air supply hose extending from the pump, the atmosphere, and the corresponding air chamber, respectively.

16. A pneumatic massage apparatus according to claim 15, wherein the electromagnetic valves are attached to the massage device.
